(19) United States
(12) Patent Application Publication
(10) Pub. No.: US 2004/0075528 A1
(43) Pub. Date: Apr. 22, 2004

(54) Printed circuit heaters with ultrathin low resistivity materials

(75) Inventors: Derek C. Carbin, North Bennington, VT (US); Jeffrey T. Gray, Cambridge, NY (US); John A. Andresakis, Clifton Park, NY (US)

Correspondence Address: Richard S. Roberts, Roberts & Mercanti, LLP, P.O. Box 484, Princeton, NJ, 08542-0484, US

(73) Assignee: OAK-MITSUI, Inc.

(21) Appl. No.: 10/278,184

(22) Filed: Oct. 22, 2002

(51) Int. Cl. H01C 1/012

(52) U.S. Cl. 338/307

(57) ABSTRACT

A printed circuit heater and process for forming a printed circuit heater are described. The printed circuit heater is formed by depositing a thin metal layer onto a surface of a metal carrier foil, forming a composite. The thin metal layer has a thickness of about 0.1 μm to about 2 μm. The composite is attached to a substrate such that the thin metal layer is in contact with the substrate, forming a laminate. At least a portion of the metal carrier foil is selectively removed from portions of the laminate. The thin metal layer is patterned and etched such that the etched thin metal layer has a heat density of from about 0.5 watts/in² to about 20 watts/in² at working voltages from about 3 volts to about 600 volts. The remaining portions of the metal carrier foil, if any, can be selectively removed to thereby provide low resistance busses within the circuit, thus eliminating the need for multiple external connections, and to facilitate evenness of heat distribution.

### BACKGROUND OF THE INVENTION

1. Field of the Invention

The present invention relates to printed circuit heaters. More particularly, the invention relates to the formation of heater circuits using ultra-thin materials.

2. Description of the Related Art

The manufacture of heater circuits is known in the art. According to conventional methods for heater circuit manufacture, a metal foil having suitable resistivity is typically laminated to a substrate, to thereby form an intermediate laminate material. The intermediate laminate material is then patterned to form a heater circuit.

Because of the mechanical integrity required for handling during slitting, sheeting, and lamination of the materials in a conventional process, there is a minimum thickness limit below which the process becomes very difficult. With very thin materials, wrinkling and tearing of the foil become too severe to manage. Since the resistive material must be relatively thick, in order to build a useful circuit, it must have a relatively high resistivity. For this purpose, engineered alloy materials such as Inconel alloy are typically employed and must be mechanically rolled to produce a suitable foil.

In the patterning step of conventional printed circuit heaters, in order to achieve even heat density distribution or to provide areas of differing heat density within a single circuit, complex serpentine shapes with carefully engineered widths and lengths and/or multiple external connections are generally necessary.

It would therefore be desirable to devise a method for manufacturing heater circuits that allows thinner materials to be used, allows for comparatively simple circuit designs, and only requires a minimum of external connections. The present invention provides a solution to these problems.

According to the invention, a printed circuit heater is formed by first depositing a thin metal layer onto a surface of a metal carrier foil, thereby forming a composite. The composite is then attached to a substrate such that the thin metal layer is in contact with the substrate, thereby forming a laminate. At least a portion of the metal carrier foil is selectively removed from portions of the laminate. The thin metal layer is then patterned and etched such that the etched thin metal layer has a heat density of from about 0.5 watts/in² to about 20 watts/in² at useful working voltages. Optionally, the selective removal of portions of the carrier metal is capable of providing low resistance busses connecting various heating elements together. These busses allow for even heat distribution using very simple circuit configurations and eliminate the need for multiple external connections even for circuits containing areas of differing heat density.

The resulting product is a printed circuit heater formed from ultra-thin materials, having simple circuit designs and only requiring a minimum of external connections.

### SUMMARY OF THE INVENTION

The invention provides a process for forming a printed circuit heater comprising the steps of:

a) depositing a thin metal or metal alloy layer onto a surface of a metal carrier foil, which thin metal or metal alloy layer has a thickness of about 0.1 μm to about 2 μm, thereby forming a composite;

b) attaching the composite to a substrate such that the thin metal or metal alloy layer is in contact with the substrate, thereby forming a laminate;

c) selectively removing at least a portion of the metal carrier foil from portions of the laminate; and

d) patterning and etching the thin metal or metal alloy layer such that the etched thin metal or metal alloy layer has a heat density of from about 0.5 watts/in² to about 20 watts/in at working voltages from about 3 volts to about 600 volts.

The invention further provides a printed circuit heater formed by a process comprising the steps of:

a) depositing a thin metal or metal alloy layer onto a surface of a metal carrier foil, which thin metal or metal alloy layer has a thickness of about 0.1 μm to about 2 μm, thereby forming a composite;

b) attaching the composite to a substrate such that the thin metal or metal alloy layer is in contact with the substrate, thereby forming a laminate;

c) selectively removing at least a portion of the metal carrier foil from portions of the laminate; and

d) patterning and etching the thin metal or metal alloy layer such that the etched thin metal layer has a heat density of from about 0.5 watts/in² to about 20 watts/in² at working voltages from about 3 volts to about 600 volts.

### BRIEF DESCRIPTION OF THE DRAWINGS

FIG. 1 shows a top view of Circuits 1-3 according to the Examples.

FIG. 2 shows a top view of Circuit 4 according to the Examples.

### DETAILED DESCRIPTION OF THE PREFERRED EMBODIMENT

The invention provides a printed circuit heater and a method for its production. According to the invention, a thin metal layer is deposited onto a surface of a metal carrier foil, thereby forming a composite. Suitable metal carrier foils for the invention include, without limitation, copper, zinc, brass, chrome, nickel, aluminum, stainless steel, iron, gold, silver, titanium and combinations and alloys thereof. Most preferably, the metal carrier foil comprises copper. The foil preferably has a thickness of from about 5 μm to about 200 μm, more preferably from about 5 μm to about 50 μm, and most preferably from about 12 μm to about 35 μm.

Copper foils are preferably produced by electrodepositing copper from an electrolytic solution onto a rotating metal drum as is well known in the art. The side of the foil next to the drum is typically the smooth or shiny side, while the other side, known as the matte side, has a relatively rough surface. The drum is usually made of stainless steel or titanium which acts as a cathode and receives the copper as it is deposited by electroplating from the solution. As the drum turns, the plated copper is peeled from it as a foil and is subsequently cut to the required size.

Prior to application of the thin metal layer, the carrier foil may optionally be roughened, passivated or otherwise treated on one or both sides by micro-etching, electrolytic treatment, electrolytic nodulation or other techniques well known in the art. Such surface treatment may be used to promote better adhesion to the substrate material or to prevent oxidation or tarnishing.

The thin metal layer, which is deposited onto the metal carrier foil, preferably comprises materials such as nickel, tin, palladium platinum, chromium, titanium, molybdenum or alloys thereof. Most preferably the thin metal layer comprises nickel or tin. Preferably, the thin metal layer has a bulk resistivity of about 15 μΩ-cm or less, preferably from about 5 μΩ-cm to about 15 μΩ-cm and most preferably from about 8 μΩ-cm to about 12 μΩ-cm.

The thin metal layer preferably has a thickness of from about 0.1 μm to about 2 μm, more preferably from about 0.1 μm to about 1 μm, and most preferably from about 0.4 μm to about 0.6 μm.

The thin metal layer is preferably deposited onto the metal carrier foil by conventional methods such as electroplating, electroless plating, electrolytic deposition, coating, sputtering, evaporation, or lamination.

Electroplating is most preferred. In one preferred embodiment, a thin metal layer comprising nickel is plated onto the metal carrier foil using a nickel sulfamate bath. In another preferred embodiment, the thin metal layer is plated onto the metal carrier foil via Watts nickel techniques.

The composite, comprising the thin metal layer on the metal carrier foil, is then attached to a substrate such that the thin metal layer is in contact with the substrate, thereby forming a laminate.

Typical substrates include those suitable to be processed into a printed circuit or other microelectronic device. Preferred substrates for the present invention are polymeric substrates and include, without limitation, materials comprising epoxy, polyester, polyimide, teflon, silicone, liquid crystal polymers and polymers reinforced with materials such as glass fiber, aramid fiber (Kevlar), and aramid paper (Thermount), or combinations thereof. Of these, a non-reinforced polyimide or silicone film substrate is the most preferred. The preferred thickness of the substrate is of from about 5 μm to about 200 μm, more preferably from about 5 μm to about 50 μm.

The composite is preferably attached to the substrate by lamination at a temperature, pressure and time appropriate for the materials chosen. Conventional lamination techniques known to those skilled in the art are preferred, such as autoclave lamination, vacuum or non-vacuum hydraulic pressing, and hot roll lamination, but any other conventional means of attaching the foil to the substrate are claimed as within the scope of the present invention.

In one preferred embodiment, the composite is laminated to the substrate via an intermediate adhesive-coated film. Examples of suitable adhesive-coated films include, without limitation, adhesive coated polyimide, polyester or silicone films, and epoxy, polyimide or teflon pre-pregs. Examples of suitable adhesives include, without limitation, epoxy, polyimide, and acrylic.

According to the invention, at least a portion of the metal carrier foil is next selectively removed from portions of the laminate. In one preferred embodiment, all of the metal carrier foil is removed from the laminate. In another preferred embodiment of the invention, portions of the metal carrier foil are not removed from the laminate, but are left as an etched pattern of carrier foil according to the design of the heater circuit. In one embodiment, the etched pattern includes at least one electrically conductive buss. The etched pattern may be formed using any suitable conventional photolithographic technique, such as by using a photoresist composition. For example, in one embodiment, a photoresist may first be deposited onto the metal carrier foil.

The photoresist is imagewise exposed to actinic radiation such as light in the visible, ultraviolet or infrared regions of the spectrum through a mask, or scanned by an electron beam, ion or neutron beam or X-ray radiation. Actinic radiation may be in the form of incoherent light or coherent light, for example, light from a laser. The photoresist is then developed using a suitable developing agent, such as an aqueous alkaline solution of sodium carbonate, thereby removing non-exposed areas of the photoresist, and revealing underlying portions of the metal carrier foil.

Subsequently, the revealed underlying portions of the metal carrier foil are removed, preferably through conventionally known etching techniques such as acid etching or alkaline etching, while not removing the portions of the metal carrier foil underlying the remaining photoresist. Preferably, portions of the metal carrier foil are etched away to form busses and expose the underlying thin metal layer. Suitable etchants non-exclusively include acidic solutions, such as cupric chloride (preferable for etching of nickel) or nitric acid (preferable for etching of tin), or alkaline solutions such as ammonium chloride/ammonium hydroxide. Also preferred are ferric chloride or sulfuric peroxide (hydrogen peroxide with sulfuric acid). It is preferred that an appropriate etchant be chosen so that the exposed carrier metal is removed, without damage to the underlying thin metal layer. In a most preferred embodiment, a metal carrier foil comprising copper is etched away using an ammoniacal etchant. Any remaining photoresist may then optionally be removed, such as by stripping with a suitable solvent. The remaining structure may then be rinsed and dried.

Next, the thin metal layer is patterned and etched. Such may be done using any suitable conventional method known in the art, such as those described above for patterning and etching the metal carrier foil using a photoresist followed by imagewise exposure, development, and etching with a suitable etchant. Suitable etchants are described above. In a most preferred embodiment, a thin metal layer comprising nickel is etched away using an acidic etchant.

An important feature of the present invention is that the etched thin metal layer has a heat density of from about 0.5 watt/in² to about 20 watts/in² at useful working voltage. More preferably, the heat density ranges from about 1 watt/in² to about 10 watts/in², and most preferably the heat density ranges from about 1 watt/in² to about 5 watts/in² The useful voltage preferably ranges from about 3 volts to about 600 volts alternating or direct current, more preferably from about 9 volts to about 240 volts, and most preferably from about 12 volts to about 120 volts.

Optionally, but preferably, a protective film cover may be applied to the etched thin metal layer. Suitable materials for the protective film cover include, without limitation, materials comprising epoxy, polyester, polyimide, teflon, silicone, liquid crystal polymers and polymers reinforced with materials such as glass fiber, aramid fiber (Kevlar), and aramid paper (Thermount), or combinations thereof. Of these, a non-reinforced polyimide or silicone film is preferred. The protective film cover may be applied by conventional techniques such as lamination. The protective film cover preferably has a thickness ranging from about 5 μm to about 200 μm, more preferably from about 5 μm to about 50 μm.

The result of this process is the formation of a relatively inexpensive printed circuit heater using ultra-thin materials. It is also within the scope of the present invention to form double-sided printed circuit heater structures, multi-layer structures, and single, double or multi-layer structures embedded in conventional multi-layer circuits.

The following non-limiting examples serve to illustrate the invention. It will be appreciated that variations in proportions and alternatives in elements of the components of the invention will be apparent to those skilled in the art and are within the scope of the present invention.

### EXAMPLE 1

Standard electrodeposited copper foil was electroplated on the shiny (drum) side with 6.5 g m² of nickel. The bath composition and plating conditions were as follows:

Bath Composition:

400 g/l Nickel Sulphamate Tetrahydrate

15 g/l Nickel Chloride Hexahydrate

30 g/l Boric Acid

Plating Conditions:

55° C. Bath Temperature

10 A/dm² Plating Current

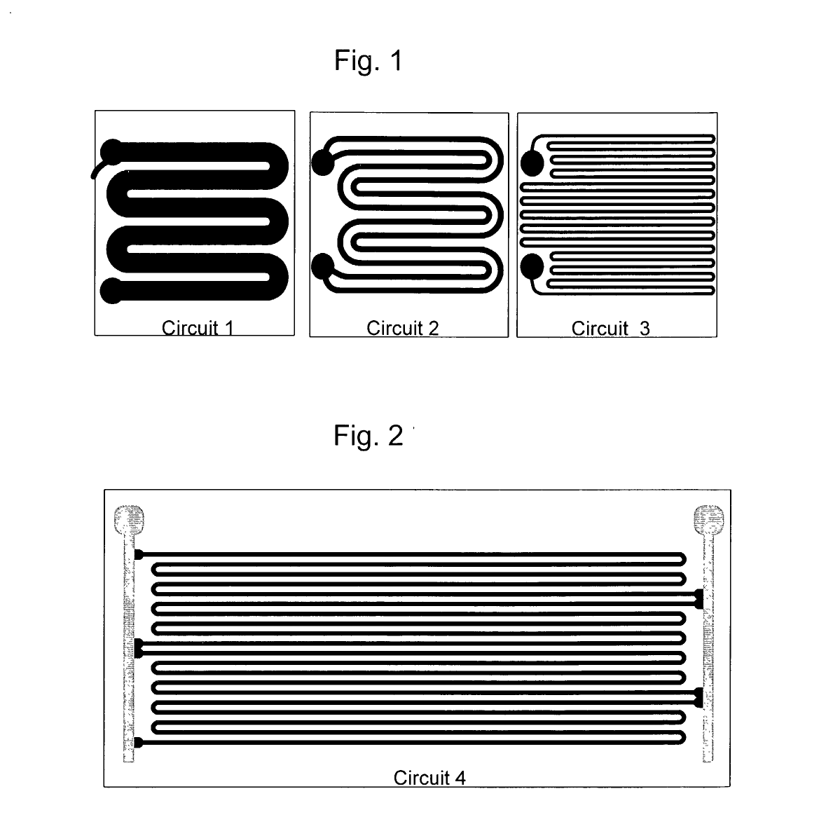

After plating, the foil was laminated nickel side down to adhesive coated polyimide film to form a laminate. The copper was then removed using an ammonium hydroxide/ammonium chloride etchant solution. The laminate was rinsed and dried before a standard dry film photoresist was applied to the nickel surface. Next, the photoresist was imaged and developed using appropriate artwork for forming the three circuit patterns shown in FIG. 1. The laminate was then placed in a standard cupric chloride etching solution for 5 seconds. Finally the photoresist was stripped using standard chemistry and the finished circuit dried.

Circuit 4, shown in FIG. 2, was prepared using the same plating and laminating processes as Circuits 1-3, but with a photoresist applied, imaged, and developed to prevent portions of the copper carrier material from being removed during the first etching step. The gray shaded portions of the circuit pattern shown in FIG. 2 are the areas where these copper “busses” were allowed to remain.

### Results

The materials processed very well and the resulting circuits were of very good quality. The circuits were tested vertically in free air at 20° C. with the results shown in Table 1.

TABLE 1
Results shown for Circuits 1-4 tested vertically in free air at 20° C.

| | | | | | | Steady State |
|---|---|---|---|---|---|---|
| | Applied | Measured | | Power | | Surface |
| | Voltage | Current | Resistance | Dissipation | Heat Density | Temperature |
| Circuit | (Volts) | (Amps) | (Ohms) | (Watts) | (Watts/Meter²) | (Deg C.) |
| 1 | — | — | — | — | — | 20 |
| | 4.9 | 0.325 | 15 | 1.6 | 705 | 38 |
| | 9.8 | 0.535 | 18 | 5.2 | 2,322 | 71 |
| | 14.7 | 0.640 | 23 | 9.4 | 4,166 | 108 |
| | 17.5 | 0.678 | 26 | 11.8 | 5,241 | 132 |
| | 21.8 | 0.725 | 30 | 15.8 | 7,010 | 154 |
| | 26.2 | 0.765 | 34 | 20.0 | 8,876 | 183 |
| 2 | — | — | — | — | — | 21 |
| | 4.9 | 0.190 | 26 | 0.9 | 411 | 33 |
| | 9.8 | 0.310 | 32 | 3.0 | 1,345 | 54 |
| | 4.7 | 0.390 | 38 | 5.7 | 2,539 | 82 |
| | 17.5 | 0.425 | 41 | 7.4 | 3,287 | 93 |
| | 21.8 | 0.463 | 47 | 10.1 | 4,472 | 118 |
| | 26.2 | 0.580 | 45 | 15.2 | 6,730 | 143 |
| 3 | — | — | — | — | — | 21 |
| | 9.8 | 0.027 | 363 | 0.3 | 117 | 26 |
| | 14.7 | 0.038 | 384 | 0.6 | 249 | 29 |
| | 26.2 | 0.065 | 403 | 1.7 | 754 | 42 |
| | 120* | 0.191* | 628 | 11.5* | 5,077* | 128 |
| 4 | 120* | 1.24* | 97 | 74.2* | 6643* | 150 |

*AC Volts, AC Amps, RMS Watts

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A process for forming a printed circuit heater comprising the steps of:
a) depositing a thin metal or metal alloy layer onto a surface of a metal carrier foil, which thin metal or metal alloy layer has a thickness of about 0.1 μm to about 2 μm, thereby forming a composite;
b) attaching the composite to a substrate such that the thin metal or metal alloy layer is in contact with the substrate, thereby forming a laminate;
c) selectively removing at least a portion of the metal carrier foil from portions of the laminate; and
d) patterning and etching the thin metal or metal alloy layer such that the etched thin metal or metal alloy layer has a heat density of from about 0.5 watts/in² to about 20 watts/in² at voltages from about 3 volts to about 600 volts.

2. The process of claim 1 wherein the metal carrier foil comprises copper.

3. The process of claim 1 wherein the thin metal layer comprises nickel.

4. The process of claim 1 wherein the metal carrier foil comprises copper and the thin metal layer comprises nickel.

5. The process of claim 1 wherein the substrate comprises a polyimide.

6. The process of claim 1 wherein the substrate comprises silicone.

7. The process of claim 1 wherein the thin metal layer comprises nickel, the metal carrier foil comprises copper and the substrate comprises polyimide.

8. The process of claim 1 wherein the then metal layer comprises nickel, the metal carrier foil comprises copper and the substrate comprises silicone.

9. The process of claim 1 wherein the thin metal layer has a thickness ranging from about 0.4 μm to about 0.6 μm.

10. The process of claim 1 wherein the laminate has a thickness ranging from about 25 μm to about 50 μm.

11. The process of claim 1 further comprising the step of applying a protective film cover to the circuit after patterning and etching the thin metal layer.

12. The process of claim 1 wherein all of the metal carrier foil is removed in step (c).

13. The process of claim 1 wherein less than all of the metal carrier foil is removed in step (c).

14. The process of claim 1 wherein the selective removal of step (c) results in the formation of at least one electrically conductive buss.

15. A printed circuit heater formed by a process comprising the steps of:
a) depositing a thin metal or metal alloy layer onto a surface of a metal carrier foil, which thin metal or metal alloy layer has a thickness of about 0.1 μm to about 2 μm, thereby forming a composite;
b) attaching the composite to a substrate such that the thin metal or metal alloy layer is in contact with the substrate, thereby forming a laminate;
c) selectively removing at least a portion of the metal carrier foil from portions of the laminate; and
d) patterning and etching the thin metal or metal alloy layer such that the etched thin metal layer has a heat density of from about 0.5 watts/in² to about 20 watts/in² at voltages from about 3 volts to about 600 volts.

16. The printed circuit heater of claim 15 wherein the metal carrier foil comprises copper.

17. The printed circuit heater of claim 15 wherein the thin metal layer comprises nickel.

18. The printed circuit heater of claim 15 wherein the metal carrier foil comprises copper and the thin metal layer comprises nickel.

19. The printed circuit heater of claim 15 wherein the substrate comprises a polyimide.

20. The printed circuit heater of claim 15 wherein the substrate comprises silicone.

21. The printed circuit heater of claim 15 wherein the thin metal layer comprises nickel, the metal carrier foil comprises copper and the substrate comprises polyimide.

22. The printed circuit heater of claim 15 wherein the then metal layer comprises nickel, the metal carrier foil comprises copper and the substrate comprises silicone.

23. The printed circuit heater of claim 15 wherein the thin metal layer has a thickness ranging from about 0.4 μm to about 0.6 μm.

24. The printed circuit heater of claim 15 wherein the laminate has a thickness ranging from about 25μ to about 50μ.

25. The printed circuit heater of claim 15 further comprising a protective film cover which has been applied after the patterning and etching of the thin metal layer.

26. The printed circuit heater of claim 15 wherein all of the metal carrier foil has been removed in step (c).

27. The printed circuit heater of claim 15 wherein less than all of the metal carrier foil has been removed in step (c).

28. The printed circuit heater of claim 15 wherein the selective removal of step (c) results in the formation of at least one electrically conductive buss.
